(19) United States
(12) Patent Application Publication
(10) Pub. No.: US 2018/0212328 A1
(43) Pub. Date: Jul. 26, 2018

(54) WIRELESS DEVICE

(71) Applicant: KABUSHIKI KAISHA TOSHIBA, Minato-ku (JP)

(72) Inventors: Koji AKITA, Yokohama (JP); Yukako TSUTSUMI, Kawasaki (JP)

(73) Assignee: KABUSHIKI KAISHA TOSHIBA, Minato-ku (JP)

(21) Appl. No.: 15/691,905

(22) Filed: Aug. 31, 2017

(30) Foreign Application Priority Data
Jan. 23, 2017 (JP) 2017-009752

(51) Int. Cl. H01Q 9/04; H01Q 3/34; H01Q 1/52; H01Q 1/48

(52) U.S. Cl. CPC H01Q 9/0464; H01Q 1/48; H01Q 1/52; H01Q 3/34

(57) ABSTRACT

A wireless device according to one aspect of the present invention includes an RF signal circuit, an antenna, and a focuser. The focuser includes a first and a second region. One of the regions transmits radio waves, and the other blocks radio waves or changes the phase of radio waves. In a plan view from the antenna, the shape of the first region is a circle and the shape of the second region is an annular ring with an inner diameter equal to the diameter of the first region. The antenna is on the center axis of the circle. The circuit is arranged point asymmetrically across the axis in a plan view from the first region. At least part of the circuit is included in an orthogonal projection of the first region to a plane which is vertical to the axis and on which the circuit is present.

### CROSS-REFERENCE TO RELATED APPLICATION (S)

This application is based upon and claims the benefit of priority from Japanese Patent Application No. 2017-009752, filed Jan. 23, 2017; the entire contents of which are incorporated herein by reference.

### FIELD

Embodiments described herein relate generally to a wireless device.

### BACKGROUND

Fresnel zone plates offer focusing effects that focus radio waves and increase energy density. Accordingly, antenna devices that include Fresnel zone plates in front are known to improve antenna gain in front. For this reason, an antenna device including a Fresnel zone plate can transmit a radio frequency (RF) signal contained in radio waves to a farther point than an antenna device that does not have a Fresnel zone plate.

However, if the distance between an RF signal circuit for processing RF signals and an antenna is shortened in order to reduce a transmission loss between the RF signal circuit and the antenna, radio waves that are inevitably generated in the RF signal circuit may also be focused by the Fresnel zone plate. This causes a problem of the amplification of unnecessary signals from the RF signal circuit and thus an increase in the occurrence of interference around the antenna.

### BRIEF DESCRIPTION OF THE DRAWINGS

FIG. 1 is a perspective view of one example of a wireless device according to a first embodiment;

FIG. 2 is a plan view of the wireless device shown in FIG. 1;

FIG. 3 is a diagram for explaining Fresnel zones;

FIG. 4 is an end view of the wireless device shown in FIG. 1;

FIG. 5 is a plan view for explaining another example of a focuser;

FIG. 6 is a diagram showing an example configuration of a wireless device in which unnecessary radio waves are focused by a focuser;

FIG. 7 is a diagram showing an example focuser configured with a single structure formed of a dielectric;

FIG. 8 is a diagram showing one example of the ground of the wireless device according to a second embodiment;

FIG. 9 is a diagram showing a modification of the ground of the wireless device according to the second embodiment; and

FIG. 10 is a diagram showing a modification of the ground of the wireless device according to the second embodiment.

### DETAILED DESCRIPTION

A wireless device according to one embodiment of the present invention suppresses focusing effects for unnecessary signals while keeping focusing effects for specific signals.

A wireless device according to one aspect of the present invention includes an RF signal circuit, an antenna, and a focuser. The focuser includes at least a first region and a second region. One of the first region and the second region transmits radio waves, and the other blocks radio waves or changes the phase of radio waves. The shape of the first region is a circle in a plan view from the antenna. The shape of the second region is an annular ring with an inner diameter equal to the diameter of the first region in a plan view from the antenna. The antenna is on the center axis of the circle of the first region. The RF signal circuit is arranged point asymmetrically across the center axis of the first region in a plan view from the first region. At least part of the RF signal circuit is included in an orthogonal projection of the first region to a plane which is vertical to the center axis and on which the RF signal circuit is present.

Below, a description is given of embodiments of the present invention with reference to the drawings. The present invention is not limited to the embodiments.

### First Embodiment

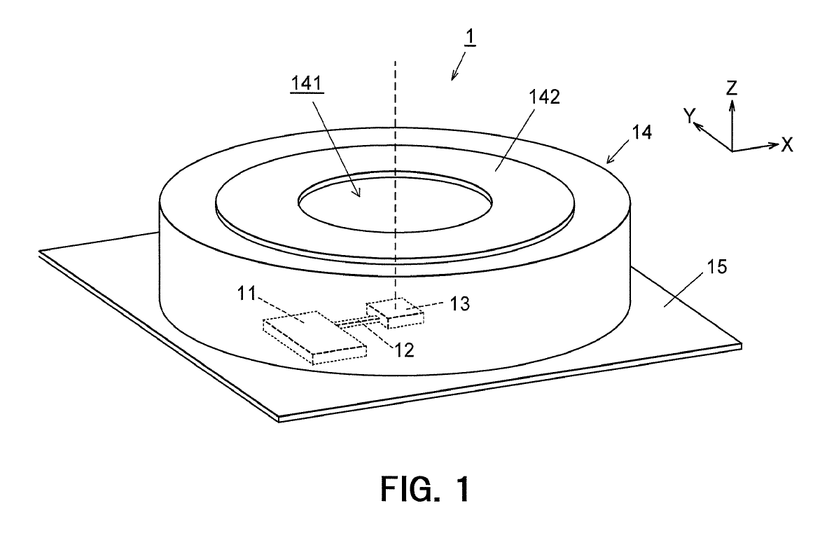

FIG. 1 is a perspective view of one example of a wireless device according to the first embodiment. The wireless device according to the first embodiment includes an RF signal circuit 11, a transfer line 12, an antenna 13, and a focuser 14. The focuser 14 includes at least a first region 141 and a second region 142.

The wireless device 1 in FIG. 1 includes a substrate 15, and the RF signal circuit 11, the transfer line 12, and the antenna 13 are provided on the top surface of the substrate 15. Note that the substrate 15, which is shown for convenience to explain the positions of the components of the first embodiment, is not necessarily provided. For example, the substrate 15 may be a part of the focuser 14. Further, other components may be included in the wireless device 1.

Suppose that the direction parallel with the center axis (indicated by the dotted line in FIG. 1) of the circle of the first region 141 is the vertical direction. In addition, the Z axis of the rectangular coordinate system indicates the vertical direction. Therefore, the X-Y plane is a horizontal plane vertical to the center axis. Moreover, the direction extending from the antenna 13 to the first region 141 is the upward direction.

The RF signal circuit 11 is a circuit for transmission, reception, or both of RF signals. The RF signal circuit 11 is configured to process RF signal and can be a known circuit. For example, an integrated circuit IC may be used.

The transfer line 12 is wiring for transmitting RF signals. The transfer line 12 is configured to transmit RF signals to/from the RF signal circuit 11 and the antenna 13.

The antenna 13 performs transmission, reception, or both of radio waves related to RF signals. To transmit radio waves, the antenna 13 converts RF signals received from the RF signal circuit 11 to radio waves and emits the radio waves to a space. Upon reception of radio waves, the antenna 13 converts received radio waves to RF signals and sends the RF signals to the RF signal circuit 11 through the transfer line 12.

There is no limitation on the type of the antenna 13. When the antenna 13 is a flat antenna, for example, a patch antenna, a dipole antenna, a monopole antenna, an inverted-F antenna, or the like may be used. When the antenna 13 is other than a flat antenna, for example, a chip antenna, a dielectric antenna, a waveguide antenna, or the like may be used. It should be noted that these are merely illustrative and the antenna 13 is not limited to these antennas.

The focuser 14 provides focusing effects that allow radio waves transmitted or received by the antenna 13 to be focused so that energy density can increase. For this reason, the focuser 14 has regions for obtaining focusing effects, and the antenna gain of the wireless device 1 increases from the antenna 13 side toward the regions for obtaining focusing effects.

The first region 141 and the second region 142 of the focuser 14 are regions for obtaining focusing effects. The first region 141 and the second region 142 are distinguished by whether they are a region that transmits radio waves (radio wave transmitting region) or a region that does not transmit radio waves (radio wave non-transmitting region). Alternatively, they are distinguished by whether they are a radio wave transmitting region or a region that changes the phase of radio waves (radio wave phase changing region). In other words, one of the first region 141 and the second region 142 transmits radio waves. The other region blocks radio waves or changes the phase of radio waves.

The radio wave transmitting region may be made of a material (radio wave transmitting material) that transmits radio waves, such as a dielectric. Alternatively, the radio wave transmitting region may be made of air. In other words, the radio wave transmitting region may be a through hole provided in the focuser 14. The radio wave non-transmitting region is made of a material that does not transmit radio waves (radio wave non-transmitting material), such as metal. Use of metal as a radio wave non-transmitting material enhances signal shielding, thereby increasing focusing effects. The radio wave phase changing region is made of a material that transmits radio waves and can change the phase of radio waves (radio wave phase changing material), such as a dielectric. Use of a dielectric as a radio wave phase changing material makes the focuser 14 light compared with use of metal as a radio wave non-transmitting material.

The shape of the first region 141 is circular in a plan view from the antenna 13. The shape of the second region 142 is an annular ring the inner diameter of which is equal to the diameter of the first region 141 in a plan view from the antenna 13. It should be noted that these plan views are not necessarily actually visible. In addition, the antenna 13 is on the center axis of the circle of the first region 141.

With these characteristics, the first region 141 and the second region 142 of the focuser 14 function in the same manner as a Fresnel zone plate. A typical Fresnel zone plate has a configuration that alternately includes an annular ring, which transmits radio waves generally, and an annular ring, which blocks radio waves. However, the innermost region in the Fresnel zone plate is not annular but circular.

In the Fresnel zone plate, the annular ring that transmits radio waves and the annular ring that blocks radio waves correspond to the n-th (n is an integer of one or more) Fresnel zone and the (n+1)-th Fresnel zone, respectively. Thus, the Fresnel zone plate blocks radio waves with the phase opposite to that of radio waves that it transmits, and mutually intensifies transmitted radio waves at the focus (the position of another wireless device that receives radio waves), thereby providing focusing effects.

The focuser 14 may include other regions than the regions for obtaining focusing effects and these other regions in the focuser 14 may have any configuration. For this reason, the configuration of the focuser 14 may vary depending on the configuration, application, and the like of the wireless device 1. For example, the shape of the focuser 14 viewed from above, which is circular in FIG. 1, may be polygonal. In addition, although the outer edge of the second region 142 is inner than the outer edge of the focuser 14 on the top surface in FIG. 1, the outer edge of the second region 142 may match the outer edge of the focuser 14 on the top surface.

The configuration of the focuser 14 will now be described with reference to FIG. 1. The focuser 14 shown in FIG. 1 includes a hollow cylinder and a plate having an annular shape (annular plate). The cylinder has a top surface but does not have a bottom surface and is installed such that it includes the antenna 13 in its hole. In addition, the cylinder has an annular plate on its top surface. Here, the cylinder is supposed to be made of a radio wave transmitting material, and the annular plate is supposed to be made of a radio wave non-transmitting material, such as metal. Accordingly, in the case shown in FIG. 1, the inner circle of the annular plate corresponds to the first region 141, and the annular plate itself corresponds to the second region 142. In addition, the first region 141 transmits radio waves, and the second region 142 blocks (reflects) radio waves.

It should be noted that in a plan view of the antenna 13, there is no limitation on the position of the second region 142 along the vertical direction if the shape of the second region 142 is an annular ring with an inner diameter equal to the diameter of the first region 141. The annular plate may be positioned either upper or lower than the top surface of the cylinder or may be contained in the top surface.

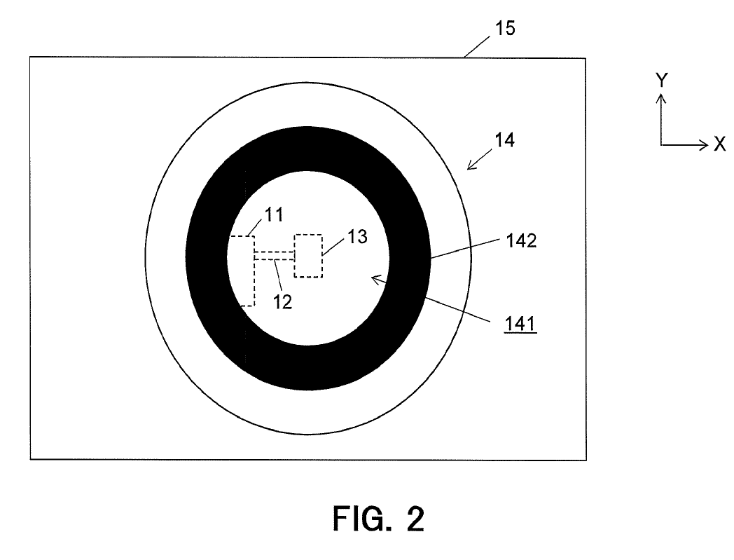

FIG. 2 is a plan view of the wireless device shown in FIG. 1. Since the center axis of the first region 141 passes through the antenna 13, the antenna 13 in FIG. 2 is present in the center of the first region 141. In addition, as shown in FIG. 2, the RF signal circuit 11 in a plan view of the first region 141 is arranged point asymmetrically across the center axis of the first region 141. If the RF signal circuit 11 is arranged point asymmetrically across the center axis, acquisition of focusing effects through unneeded signals from the RF signal circuit 11 can be prevented.

The reason will be explained with the principals of the focusing effects through the focuser 14. The following description is about transmission of radio waves from the antenna 13, and the description of reception of radio waves from the antenna 13 is similar and is therefore omitted.

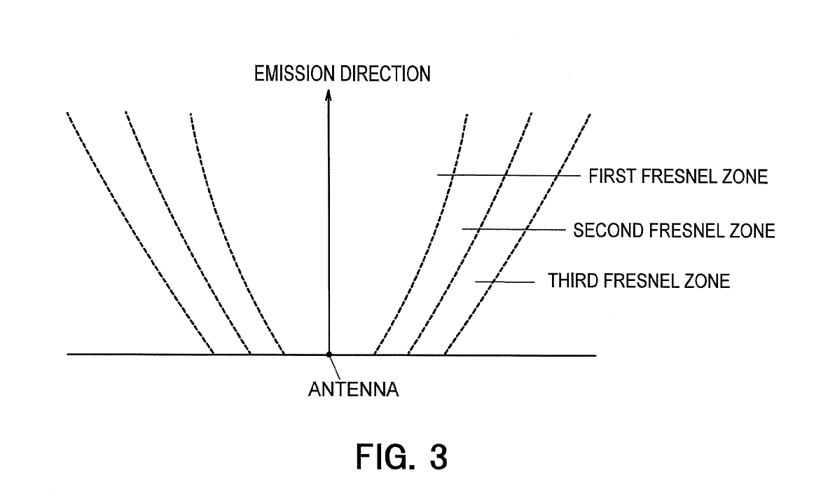

FIG. 3 is a diagram for explaining Fresnel zones. Radio waves emitted from the antenna 13 in the vertical direction of FIG. 3 travel in the form of a wavefront. The area where this signal travels is classified into a plurality of regions. Each region is referred to as a Fresnel zone. A region where, compared with when radio waves travel straight, the optical path difference at the focus is less than or equal to half of the wavelength of the radio waves is referred to as the first Fresnel zone. In particular, the first Fresnel zone corresponds to a region represented by L≤λ where the optical path difference is L and the wavelength of radio waves is λ. Similarly, when n is an integer of one or more, the n-th Fresnel zone corresponds to a region with an optical path difference that is more than (n−1) times the wavelength and at or less than n times the wavelength. In other words, a region satisfying (n−1)×λ<L≤n×λ is an n-th Fresnel zone. It should be noted that a Fresnel zone is an axisymmetric region the axis of which extends in the direction in which radio waves are emitted.

A signal traveling in an odd-numbered Fresnel zone (a Fresnel zone in which n is an odd number) and a signal traveling in an even-numbered Fresnel zone have opposite phases and cancel each other out. For this reason, blockage of radio waves traveling toward odd-numbered or even-numbered Fresnel zones reduces a component canceling out radio waves, thereby providing focusing effects.

For example, shielding the second Fresnel zone reduces a canceling component due to radio waves traveling in the second Fresnel zone, thereby providing focusing effects. Similarly, shielding the second and fourth Fresnel zones further increases focusing effects. Shielding odd-numbered Fresnel zones provides similar effects. For example, shielding the first and third Fresnel zones provides focusing effects.

It should be noted that focusing effects are provided depending on blocked radio waves. For this reason, if radio waves passing through a Fresnel zone to be shielded are not completely blocked but partly blocked, focusing effects can be obtained depending on the blocked radio waves.

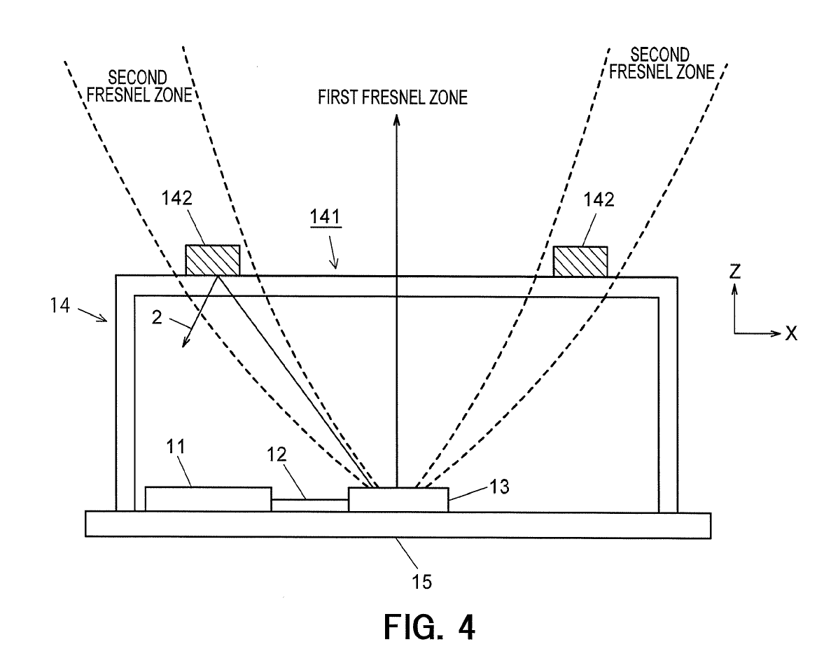

FIG. 4 is an end view of the wireless device shown in FIG. 1. Radio waves 2 shown as a solid arrow are radio waves reflected off the second region. The first region 141 serving as the inner circle of the annular plate transmits radio waves passing through the first Fresnel zone. Meanwhile, the second region 142 serving as the annular plate itself is contained in the second Fresnel zone, so that radio waves passing through the second Fresnel zone are reflected off the second region 142. This blocks at least part of radio waves passing through the second Fresnel zone. Accordingly, the focuser 14 in FIG. 1 includes regions for obtaining focusing effects and the wireless device 1 in FIG. 1 can improve upward antenna gain.

It should be noted that if, on the horizontal plane on which the second region 142 is present, the inner edge of the annular ring of the second region 142 is positioned on the boundary between the first Fresnel zone and the second Fresnel zone and the outer edge of the annular ring is positioned on the boundary between the second Fresnel zone and the third Fresnel zone, radio waves passing through the second Fresnel zone are all blocked, thereby increasing focusing effects.

On the horizontal plane, the length of the Fresnel zone in the radial direction depends on the distance to the antenna 13 and the wavelength of RF signals. Therefore, the size and position of the second region 142 are determined depending on the wavelength of the target RF signal. For example, if the wavelength of the RF signal and the position of the second region 142 in the vertical direction are determined, the allowable range of the width of the annular ring of the second region 142 (the length between the inner diameter and the outer diameter) is determined.

For example, if the RF signals are microwaves and the outer diameter of the annular ring of the second region 142 is about 20 cm, changing RF signals to millimeter-waves results in the outer diameter of the annular ring of the second region 142 of about 10 mm. Therefore, in the case where the RF signals are millimeter-waves, the first region 141 and the second region 142 can be made smaller than in the case of microwaves.

It is preferable that the distance between the antenna 13 and the radio wave non-transmitting region among the first region 141 and the second region 142 in the vertical direction be not an integral multiple of half of the wavelength of the RF signals. If this distance is an integral multiple of half of the wavelength of the RF signals, radio waves from the antenna 13 are reflected off the radio wave non-transmitting region, so that standing waves to the radio waves from the antenna 13 are generated. For this reason, the focuser 14 is preferably placed in such a position that the distance between the radio wave non-transmitting region and the antenna 13 does not become an integral multiple of half of the wavelength of the RF signals. This avoids a phenomenon in which focusing effects decrease due to standing waves.

Since the above description is based on the premise that the cylinder is made of a radio wave transmitting material and the annular plate is made of a radio wave non-transmitting material, the first region 141 transmits radio waves, and the second region 142 blocks radio waves. Alternatively, the first region 141 may block radio waves and the second region 142 may transmit radio waves. For example, if the cylinder is made of a radio wave non-transmitting material but a region of the annular ring on the top surface of the cylinder is made of a radio wave transmitting material, the first region 141 blocks radio waves and the second region 142 transmits radio waves. In this case, radio waves passing through the second Fresnel zone reach the receiver. Since radio waves passing through the first Fresnel zone are blocked, radio waves passing through the second Fresnel zone obtain focusing effects.

In this manner, to shield a target Fresnel zone, the focuser 14 includes at least the first region 141 and the second region 142, and one of the first region 141 and the second region 142 transmits radio waves, and the other blocks radio waves.

It should be noted that, in the above description, the first region 141 or the second region 142 blocks radio waves. However, instead of blocking radio waves, it may change the phase of radio waves. For example, the cylinder may be made of a radio wave transmitting material, and the annular plate may be made of a radio wave phase changing material. In this case, both the first region 141 and the second region 142 transmit radio waves. Note that the lengths of the first region 141 and the second region 142 in the vertical direction are adjusted so that the phases of radio waves passing through the first region 141 and radio waves passing through the second region 142 cannot be opposite. Such adjustment reduces a component canceling out radio waves, so that radio waves can obtain focusing effects.

In addition, in the above case, the lengths (thicknesses) of the first region 141 and the second region 142 in the direction in which radio waves are transmitted are preferably adjusted so that radio waves passing through the first region 141 and radio waves passing through the second region 142 can be in phase with each other. This provides mutual reinforcement between radio waves passing through the first region 141 and radio waves passing through the second region 142, thus further increasing focusing effects.

Alternatively, the radio wave phase changing region may be round cornered. With round corners of the radio wave phase changing region, dispersion of radio waves due to corners can be prevented and a problem of a reduction in focusing effects due to dispersion can be eased.

The length of the radio wave phase changing region in the vertical direction is preferably shorter than one-quarter of the effective wavelength of radio waves, transmitted or received by the antenna 13, inside the radio wave phase changing region. If this length is one-quarter of the effective wavelength, radio waves passing through the radio wave phase changing region and radio waves reflecting off the boundary with the radio wave phase changing region and passing therethrough are in opposite phases. Thus, both types of radio waves weaken each other at the focus and focusing effects therefore decrease. The longer the distance that it passes through the radio wave phase changing material, the more the attenuation while it is passing therethrough, so that the intensity of the RF signal decreases. Accordingly, the length is set shorter than one-quarter of the effective wavelength, thereby preventing a reduction in the intensity of radio waves.

For example, although radio waves from the antenna 13 pass through part of the focuser 14 (the top surface of the cylinder) before passing through a through hole which is the first region 141 in FIG. 4, if this part is formed of a dielectric, the length of this part in the vertical direction is preferably shorter than one-quarter of the effective wavelength of RF signals in the dielectric.

In FIG. 4, for the first region 141 and the second region 142, passage of radio waves through the first and second Fresnel zones are adjusted. Alternatively, passage of radio waves through the third or later Fresnel zones may be adjusted by adjusting the first region 141 and the second region 142. For example, the first region 141 may transmit radio waves coming from the first to third Fresnel zones, and the second region 142 may block radio waves from the fourth Fresnel zone. Even in this case, the influence of radio waves in the fourth Fresnel zone on radio waves in the first and third Fresnel zones is suppressed, thereby providing focusing effects.

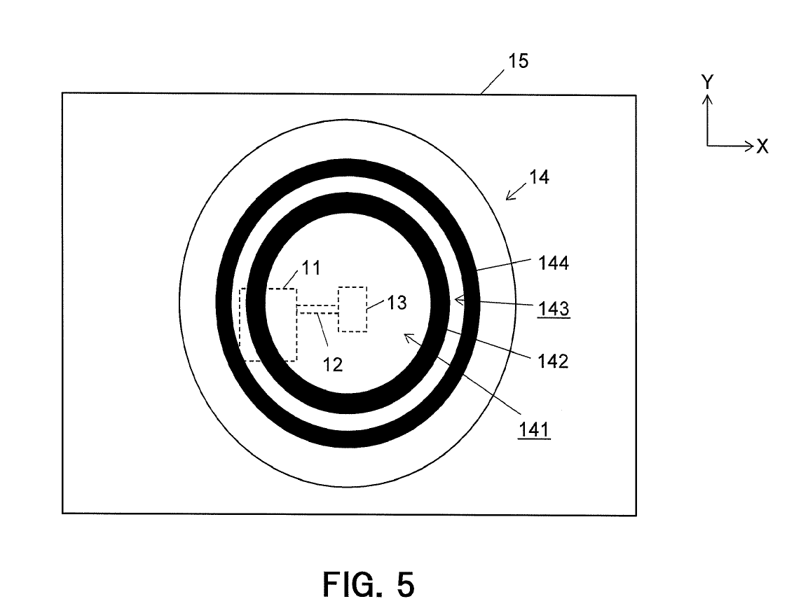

In addition, the focuser 14 may include a plurality of annular regions. In other words, the focuser 14 may include regions other than the first region 141 and the second region 142 as regions for obtaining focusing effects. FIG. 5 is a plan view for explaining another example focuser. FIG. 5 shows a third region 143 and a fourth region 144 in addition to the first region 141 and the second region 142. The shape of the third region 143 is an annular ring the inner diameter of which is equal to the outer diameter of the second region 142 in a plan view from the antenna 13. The shape of the fourth region 144 is an annular ring the inner diameter of which is equal to the outer diameter of the third region 143 in a plan view from the antenna 13. The third region 143 and the fourth region 144 are also distinguished by whether they are a radio wave transmitting region, a radio wave non-transmitting region, or a radio wave phase changing region.

To increase focusing effects, radio wave transmitting regions and radio wave non-transmitting regions or radio wave phase changing regions alternate in the radial direction in the first region 141. In the case in FIG. 5, the first region 141 and the third region 143 are radio wave transmitting regions, and the second region 142 and the fourth region 144 are radio wave non-transmitting regions. In addition, the first region 141 and the third region 143 transmit radio waves from the odd-numbered Fresnel zones, and the second region 142 and the fourth region 144 block or change the phase of radio waves from even-numbered Fresnel zones.

For example, an annular plate A, an annular plate B, a gap between the annular plate A and the annular plate B, and the size of the gap are adjusted such that the annular plate A blocks radio waves passing through the second Fresnel zone, the annular plate B blocks radio waves passing through the fourth Fresnel zone, and the gap transmits radio waves passing through the third Fresnel zone. This makes upward antenna gain higher than in the case with a single annular plate.

In the above description, n is an integer of one or more for convenience. However, n may be generalized to a decimal. For example, if n is a decimal of 1.5, the 1.5th Fresnel zone refers to a range in which the optical path difference ranges from (wavelength×0.5) to (wavelength×1.5). For example, if a focuser 14 that blocks only the 1.5th Fresnel zone is prepared, the 0.5th Fresnel zone (a component with an optical path difference of a wavelength of 0 to 0.5) and the 2.5th Fresnel zone mutually reinforce, thereby providing focusing effects.

Further focusing effects may be provided by blocking the M-th (M is an integer of one or more) Fresnel zone and the (M+2n)-th Fresnel zone or other Fresnel zones with an additional integral multiple of two. In the above description, two annular plates block the second Fresnel zone and the fourth Fresnel zone. Alternatively, they may block the second Fresnel zone and the sixth Fresnel zone.

In this manner, an optical path difference causes signals travelling in odd-numbered Fresnel zones and signals travelling in even-numbered Fresnel zones to cancel each other out, thereby generating focusing effects. Therefore, when transmitted radio waves are symmetric across the center axis of the circle of the first region 141, maximum focusing effects can be obtained. In contrast, when transmitted radio waves are asymmetric across the center axis of the circle of the first region 141, the positions of Fresnel zones deviate, which results in a reduction in focusing effects. In this embodiment, which uses this phenomenon, the antenna 13 is positioned on the center axis and the RF signal circuit is arranged point asymmetrically across the center axis.

In the wireless device 1, which emits radio waves from the antenna 13, a trace quantity of radio waves is also generated from the RF signal circuit 11 which carries current. There is a risk for focusing effects on these radio waves that do not need focusing.

If the wavelength of RF signals is short, for millimeter-waves in the order of gigahertz, for example, the signal loss in the transfer line 12 increases and the transfer line 12 is therefore preferably short. However, if the transfer line 12 is short, i.e., if the RF signal circuit 11 is close to the antenna 13, unnecessary radio waves may be focused by the focuser 14.

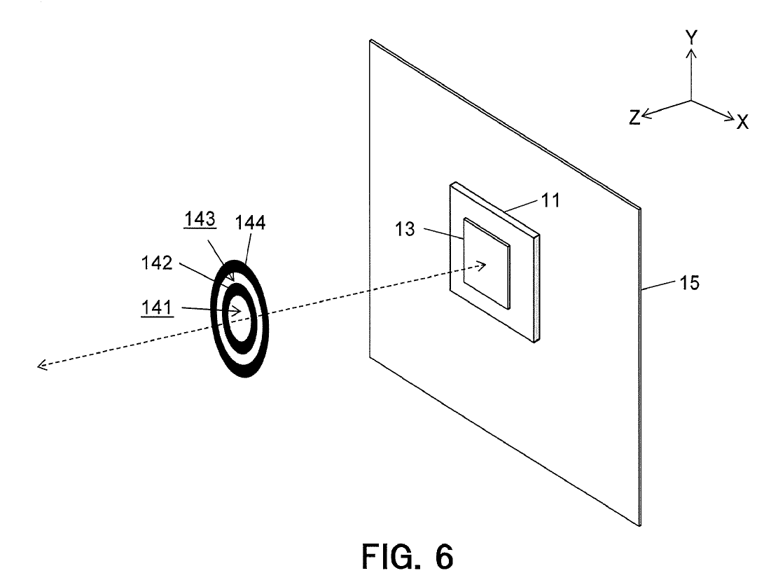

FIG. 6 is a diagram showing an example configuration of a wireless device in which unnecessary radio waves are focused by a focuser. As in the case shown in FIG. 6, if the RF signal circuit 11 is installed overlapping the antenna 13, radio waves from the RF signal circuit 11 are transmitted symmetrically across the center axis of the circle of the first region 141. Therefore, radio waves from the RF signal circuit 11 are focused by the focuser 14.

However, the RF signal circuit 11 in this embodiment is arranged point asymmetrically across the center axis of the focuser 14. Therefore, radio waves from the RF signal circuit 11 are not transmitted symmetrically across the center axis of the circle of the first region 141. Consequently, radio waves from the RF signal circuit 11 cannot obtain focusing effects through the first region 141 and the second region 142.

Particularly when at least part of the RF signal circuit 11 overlaps the first region 141 in a plan view of the wireless device 1 as shown in FIG. 2, in other words, when at least part of the RF signal circuit 11 is included in the orthogonal projection of the first region to the horizontal plane on which the RF signal circuit 11 exists, more radio waves from the RF signal circuit 11 pass through the first region 141. However, even in this case, radio waves from the RF signal circuit 11 cannot obtain focusing effects, which means this embodiment is more advantageous.

The transfer line 12 also emits radio waves. Therefore, the transfer line 12 may also be arranged point asymmetrically across the center axis in a plan view from the first region. Thus, acquisition of focusing effects can be prevented also for unnecessary radio waves emitted from the transfer line 12. Particularly when at least part of the transfer line 12 overlaps the first region 141 in a plan view of the wireless device 1 as shown in FIG. 2, in other words, when at least part of the transfer line 12 is included in the orthogonal projection of the first region to the horizontal plane on which the transfer line 12 exists, more radio waves from the transfer line 12 pass through the first region 141. However, even in this case, radio waves from the transfer line 12 cannot obtain focusing effects, which means this embodiment is more advantageous.

In view of this, even with the antenna 13, the RF signal circuit 11, and the transfer line 12 placed on the same plane, the wireless device 1 in this embodiment focuses radio waves from the antenna 13 but prevents unnecessary radio waves from the RF signal circuit 11 or the transfer line 12 from being focused.

There is no limitation on the methods of forming the radio wave transmitting region, the radio wave non-transmitting region, and the radio wave phase changing region. For example, the first region 141 and the second region 142 may be formed by bonding a radio wave transmitting material to a radio wave non-transmitting material. The first region 141 and the second region 142 may be formed by coating a surface of the radio wave transmitting material with the radio wave non-transmitting material.

As described above, the focuser 14 can have various configurations. For example, the profile of the focuser 14 in FIG. 1 is not necessarily a circle but may be a polygon. Alternatively, like the cylinder and the annular plate in FIG. 1, the focuser 14 may be configured with a plurality of structures. For example, the wireless device 1 may be provided with a plurality of poles having an annular plate mounted thereto. Similarly, the first region 141 and the second region 142 may be configured with a plurality of structures. For example, a single annular plate may be formed by a combination of two U-shaped plates.

There is no limitation on the method of fixing the focuser 14 to the wireless device 1. Fixation may be made through an adhesive. Alternatively, fixation may be made through threads, for example. The wireless device 1 may include a mounting portion to which the focuser 14 is mounted by partial insertion or hooking of the focuser 14. If the mounting portion allows the focuser 14 to be detached therefrom, exchange of the focuser 14 is possible. Therefore, the specifications of the antenna 13 can be easily changed depending on the application of the wireless device 1. For example, the focuser 14 used may be changed depending on whether it wirelessly communicates with an adjacent wireless device or it wirelessly communicates with a remote wireless device.

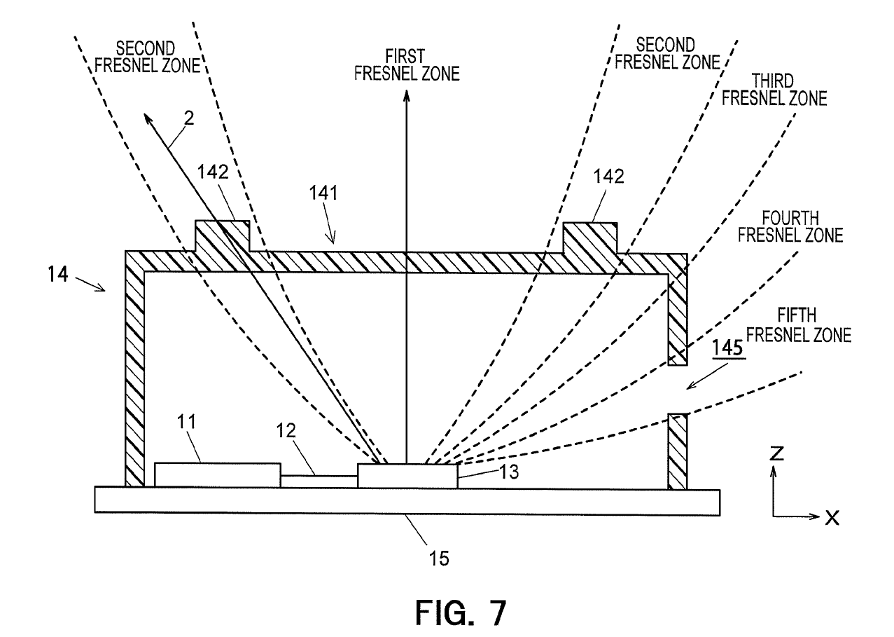

Alternatively, the focuser 14 may be configured with a single structure. For example, when a dielectric is used as a radio wave phase changing material, the focuser 14 may be a single structure formed of the dielectric. FIG. 7 is a diagram showing an example focuser configured with a single structure formed of a dielectric.

Even if the cylinder and the annular plate of the focuser 14 shown in FIG. 4 are both formed of a dielectric, a boundary occurs between the cylinder and the annular plate. There is a high possibility that even the same material produces reflected waves at the boundary. However, if the focuser 14 is configured with a single three-dimensional structure shown in FIG. 7, no boundary occurs and reflection on the boundary can be therefore avoided. Eliminating the boundary in this manner allows signals to be efficiently transmitted forward, thereby increasing focusing effects. It should be noted that in this case, a phase difference between radio waves passing through the first region and radio waves passing through the second region can be adjusted by adjusting the lengths of the first region and the second region in the vertical direction.

It should be noted that in the aforementioned case, the focuser 14 is entirely formed of a dielectric. However, not necessarily the entire focuser should be formed of a dielectric. For example, the side of the focuser 14 in FIG. 7 should not necessarily be formed of a dielectric. If a region of the focuser 14 transmitting radio waves passing through the second region is a single structure formed of a dielectric, radio waves passing through the second region are not reflected off the boundary. Therefore, the same effects as with the configuration shown in FIG. 7 can be obtained. In addition, a region of the focuser 14 which does not transmit radio waves passing through the second region should not necessarily be a dielectric.

Further, a through hole may be provided in a part of the side of the focuser 14. FIG. 7 shows a through hole 145 provided in the side of the focuser 14. If the through hole is in communication with a Fresnel zone to transmit radio waves through as shown in FIG. 7, the antenna gain can be made higher than in the case where no through hole is provided in the side. In FIG. 7, the first region 141 is a radio wave transmitting region and tends to transmit radio waves in odd-numbered Fresnel zones. Further, the through hole 145 is in communication with the fifth Fresnel zone. Therefore, the focuser 14 shown in FIG. 7 provides higher focusing effects than a focuser 14 that does not include a through hole on the side. In this manner, a structure having a through hole in communication with a Fresnel zone to transmit radio waves through can reduce signal attenuation.

As described above, according to this embodiment, the RF signal circuit 11 or the transfer line 12 generating unnecessary radio waves are arranged point asymmetrically across the center axis of the first region 141. Thus, the antenna gain is improved through the focuser 14 but unnecessary radio waves cannot obtain focusing effects through the focuser 14. Accordingly, unnecessary interference around the wireless device 1 can be reduced while keeping focusing effects for target RF signals.

### Second Embodiment

The second embodiment takes the ground in the wireless device into consideration. The description of the same points as in the first embodiment will be omitted.

A ground 16 exists in the opposite direction of the direction extending from the antenna 13 to the first region 141. In other words, the ground 16 exists below the antenna 13. The surface of the ground 16 facing the antenna 13, i.e., the top surface is referred to as a ground surface.

A ground provides a reference potential for RF signals and is formed of a conductor such as a metal. Therefore, current flowing through the ground may cause radio waves. Besides, radio waves reflected off a radio wave non-transmitting region of the focuser 14 may be reflected off the ground surface. Accordingly, in the wireless device 1 including the ground 16, radio waves from the ground surface can be focused by the focuser 14.

To prevent radio waves from the ground surface from being focused by the focuser 14, similarly to the RF signal circuit 11, the ground 16 of the second embodiment is arranged point asymmetrically across the center axis in a plan view from the first region. Radio waves from the ground surface are transmitted arranged point asymmetrically across the center axis of the circle of the first region 141, so that acquired focusing effects decrease. Particularly when the ground 16 is included in the orthogonal projection from the first region 141 toward the ground surface, more radio waves from the ground 16 pass through the first region 141 but radio waves from the ground 16 cannot obtain focusing effects, which is advantageous.

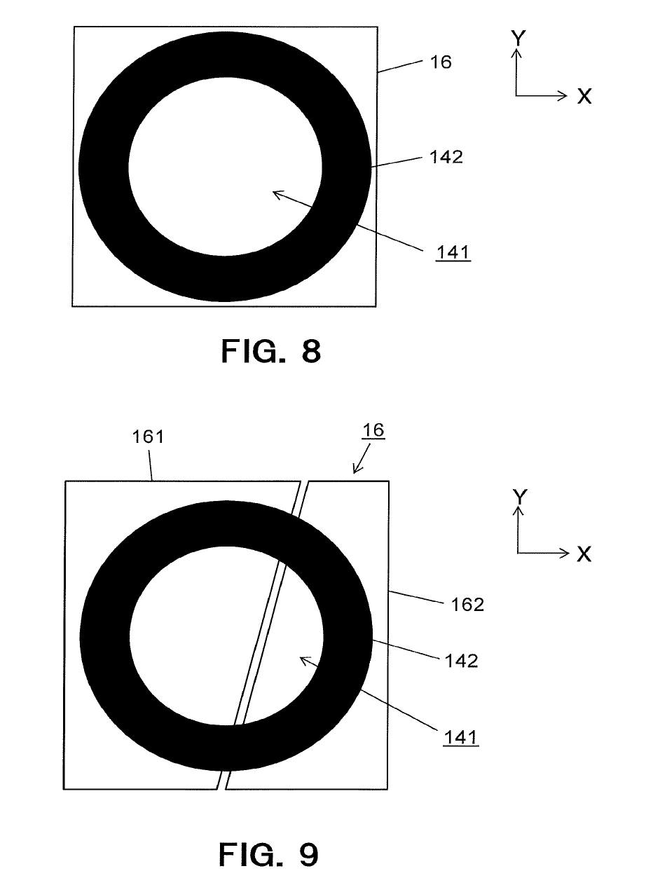

In addition, the ground 16 may have such a size that the orthogonal projection from the radio wave non-transmitting region among the first region 141 and the second region 142 to the ground surface is included in the ground surface. FIG. 8 is a diagram showing one example of the ground of the wireless device according to the second embodiment. FIG. 8 is a plan view in which the components of the wireless device 1 other than the ground 16 and the annular plate are omitted. FIG. 8 shows a black annular ring inner than the ground surface, indicating the second region 142. Therefore, the orthogonal projection from the radio wave non-transmitting region toward the ground is included in the ground surface.

Since the antenna 13 is present on the center axis of the first region 141 as shown in FIG. 4, if radio waves from the antenna 13 are reflected off the radio wave non-transmitting region, there is a high possibility that reflected waves travel away from the center axis of the first region 141. For this reason, the ground surface is preferably larger than the orthogonal projection from the radio wave non-transmitting region toward the ground surface in order to prevent reflected waves from traveling downward from the ground surface.

The wireless device 1 may include multiple grounds. For example, the components, such as the antenna 13, the RF signal circuit 11, and the transfer line 12, may be provided with respective grounds. It should be noted that if the components are provided with respective grounds, these grounds may be electrically connected to each other. Another configuration is also applicable in which one ground is divided into multiple grounds.

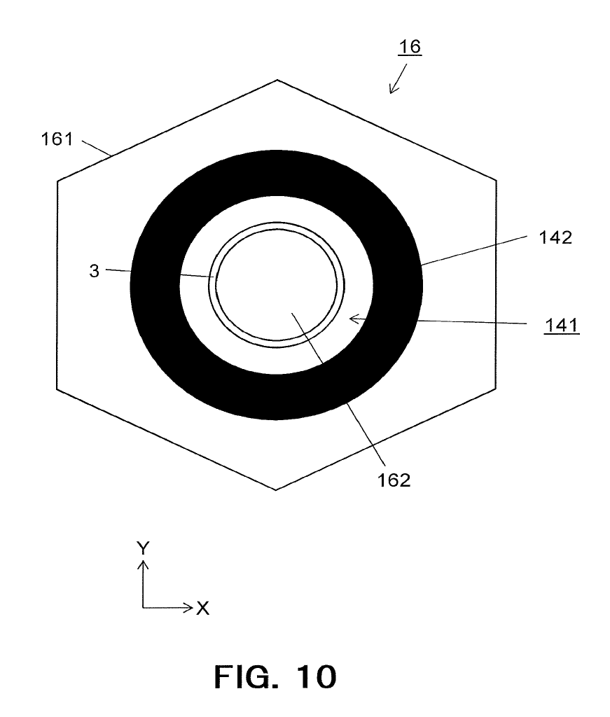

FIG. 9 is a diagram showing a modification of the ground of the wireless device according to the second embodiment. FIG. 9 shows two grounds: a first ground 161 and a second ground 162. If multiple grounds are provided, one collective surface configured with the surfaces of the multiple grounds may be regarded as a ground surface. In particular, the orthogonal projection from the radio wave non-transmitting region among the first region 141 and the second region 142 toward the collective surface is preferably included in the collective surface. In FIG. 9, the black annular ring indicating the second region 142 is included in the region where two grounds of the first ground 161 and the second ground 162 both exist, so that reflected waves can be prevented from traveling downward from the ground surface. However, a gap between the grounds is preferably small. A smaller gap leads to effects more approximate to those provided in the case where the collective surface is composed of a single ground surface.

For the ground surface, the distance from the antenna 13 to the outer edge of the ground surface is preferably non-uniform. In other words, the profile of the ground surface is preferably not a circle centered around the center axis of the first region 141. For example, the profile of the ground surface may be a polygon.

If the distance from the antenna 13 to the outer edge of the ground surface is uniform, a specific signal distribution occurs on the ground surface. This signal distribution may weaken focusing effects provided by the focuser 14. To avoid this problem, the distance from the center to the outer edge in a preferred ground surface preferably varies. It should be noted that if the wireless device 1 includes multiple grounds, the collective surface configured with multiple grounds is preferably not a circle centered around the center axis of the first region 141.

FIG. 10 is a diagram showing another modification of the ground of the wireless device according to the second embodiment. FIG. 10 also includes two grounds: a first ground 161 and a second ground 162. In the wireless device 1, an annular gap 3 is present between the first ground 161 and the second ground 162. Since the profile of the second ground 162 is a circle but the profile of the first ground 161 outer than the second ground 162 is a hexagon, the profile of the collective surface is a hexagon. Accordingly, also in the case shown in FIG. 10, focusing effects can be prevented from being weaken by a signal distribution from the ground surface.

In addition, in the second embodiment, it is preferable that the distance between the ground surface and the radio wave non-transmitting region among the first region 141 and the second region 142 in the vertical direction be not an integral multiple of half of the wavelength of the RF signals. If the distance between the ground surface and the radio wave non-transmitting region is an integral multiple of half of the wavelength of the RF signals, radio waves from the ground surface are reflected off the radio wave non-transmitting region, so that standing waves to the radio waves are generated. For this reason, the focuser 14 is preferably present in such a position that the distance between the radio wave non-transmitting region and the ground surface is not an integral multiple of half of the wavelength of the RF signals. This allows reflected waves from the ground surface to be further reflected off the radio wave non-transmitting region and avoids a phenomenon in which focusing effects decrease due to standing waves.

As described above, according to this embodiment, radio waves from the ground 16 cannot obtain focusing effects through the focuser 14. This reduces unnecessary interference due to radio waves from the ground 16. Accordingly, unnecessary interference around the wireless device 1 can be reduced while keeping focusing effects for target RF signals.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless device comprising:
an RF signal circuit;
an antenna; and
a focuser including at least a first region and a second region, one of the first region and the second region transmitting radio waves, and the other blocking radio waves or changing the phase of radio waves, wherein
the shape of the first region is a circle in a plan view from the antenna,
the shape of the second region is an annular ring with an inner diameter equal to the diameter of the first region in a plan view from the antenna,
the antenna is on the center axis of the circle of the first region,
the RF signal circuit is arranged point asymmetrically across the center axis in a plan view from the first region, and
at least part of the RF signal circuit is included in an orthogonal projection of the first region to a plane which is vertical to the center axis and on which the RF signal circuit is present.

2. The wireless device according to claim 1, further comprising:
a transfer line configured to transfer RF signals between the antenna and the RF signal circuit, wherein
the transfer line is arranged point asymmetrically across the center axis in a plan view from the first region.

3. The wireless device according to claim 1, further comprising:
a ground that is positioned in a direction opposite to a direction of the first region from the antenna and includes a ground surface facing the antenna, wherein
an orthogonal projection from one of the first region and the second region toward the ground surface is included in the ground surface, the one of the first region and the second region blocking radio waves or changing the phase of radio waves.

4. The wireless device according to claim 1, further comprising:
a ground that is positioned in a direction opposite to a direction of the first region from the antenna and includes a ground surface facing the antenna, wherein
the distance between one of the first region and the second region and the ground surface in the direction of the center axis is not an integral multiple of half of the wavelength of radio waves transmitted or received by the antenna, the one of the first region and the second region blocking radio waves or changing the phase of radio waves.

5. The wireless device according to claim 1, wherein the distance between the first region and the antenna in the direction of the center axis is not an integral multiple of half of the wavelength of radio waves transmitted or received by the antenna.

6. The wireless device according to claim 1, wherein a region of the focuser transmitting radio waves passing through one of the first region and the second region is a single structure formed of a dielectric, the one of the first region and the second region blocking radio waves or changing the phase of radio waves.

7. The wireless device according to claim 1, wherein in the focuser, the length of a radio wave phase changing region formed of a radio wave phase changing material in the direction of the center axis is shorter than one-quarter of the effective wavelength of radio waves, transmitted or received by the antenna, in the radio wave phase changing region.

8. The wireless device according to claim 1, wherein on a plane on which the annular ring of the second region is present, the inner edge of the annular ring is positioned on a boundary between a first Fresnel zone and a second Fresnel zone and the outer edge of the annular ring is positioned on a border between the second Fresnel zone and a third Fresnel zone.

9. The wireless device according to claim 1, wherein
the focuser further includes a third region,
when the first region transmits radio waves, the third region transmits radio waves, and when the first region blocks radio waves or changes the phase of radio waves, the third region blocks radio waves or changes the phase of radio waves, and
the shape of the third region is an annular ring with an inner diameter equal to the outer diameter of the second region in a plan view from the antenna.
